(19) United States
(12) Patent Application Publication
(10) Pub. No.: US 2008/0277199 A1
(43) Pub. Date: Nov. 13, 2008

(54) Ladder

(76) Inventor: Lionel F. Castonguay, Bristol, CT (US)

Correspondence Address: Pamela L. Wingood;Ohlandt, Greely, Ruggiero & Perle. L.L. P., 10th Floor, One Landmark Square, Stamford, CT, 06901-2682, US

(21) Appl. No.: 12/151,550

(22) Filed: May 7, 2008

Related U.S. Application Data
(60) Provisional application No. 60/928,021, filed on May 7, 2007.

(51) Int. Cl. E06C 5/00

(52) U.S. Cl. 182/127

(57) ABSTRACT

A ladder that provides access to a rack on a roof of a vehicle having a neck connected to a pair of legs and a plurality of rungs separating the pair of legs is provided. The ladder has a pair of stand-offs that are each connected to one of the pair of legs. A neck extension is connected to the neck and has a connector that is removably attached to the rack to permit the ladder to hang at the side of the vehicle. A ladder that provides access to a rack on a vehicle having a pair of legs that form a neck that is adjustable in length is provided. A connector operatively associated with the neck for attachment to the rack is provided. A pair of stand-offs permit the ladder to rest against the side the vehicle is provided.

This application claims the benefit of U.S. Provisional Patent Application Ser. No. 60/928,021, filed on May 7, 2007, the contents of which are incorporated by reference herein.

### BACKGROUND OF THE INVENTION

1. Field of the Invention

This invention relates to a ladder. More, particularly, this invention relates to a portable ladder for a vehicle. Still more particularly, the invention relates to a portable ladder having a hook or a cuff that is configured to connect to a truck or other vehicle having a rack on the roof or side thereof.

2. Description of Related Art

Ladders that are used with passenger or commercial vehicles to provide access to the roof of such vehicles are often cumbersome or unsafe to use. Oftentimes, such ladders are very heavy to move or unstable during use. A ladder that rests on the ground and leans against a vehicle must have a flat surface on which to rest to provide stability. Additionally, a ladder that rests on the ground is a very long, and likely heavy, compared to a ladder that hangs at the side of a vehicle and does not touch the ground for support.

Accordingly, there is a need for a ladder that provides access to the roof of a vehicle that removably connects to the top or side of a vehicle and is lightweight and adjustable.

### SUMMARY OF THE INVENTION

This disclosure provides for a ladder having a hook or cuff that permits connection to a rack at the roof or side of a truck or other vehicle to provide access to a higher roof of such a vehicle.

This disclosure also provides for a ladder having a hook or cuff that connects to a rack on the roof or side of a vehicle and hangs at the side of the vehicle.

This disclosure also provides for a ladder that is easily removed from a rack on the roof of a vehicle and easily stores either on the roof of the vehicle or inside the vehicle.

This disclosure further provides for a ladder that has covered pads extending from its side that that allow the ladder to rest against the side of a vehicle and not damage the vehicle finish.

This disclosure still further provides for a hanging ladder that is adjustable to provide lengths for different height access.

This disclosure still yet further provides for a hanging ladder that connects to a rack on the roof or side of a vehicle and is supported against the side of the vehicle with standoffs that extend from the ladder.

A ladder that provides access to a rack on a roof of a vehicle having a neck connected to a pair of legs and a plurality of rungs separating the pair of legs. The ladder has a pair of stand-offs, wherein one of the pair of stand-offs is connected to one of the pair of legs and the other of the pair of stand-off is connected to the other of the pair of legs. A neck extension is connected to the neck and has a connector that is removably attached to the rack to permit the ladder to hang at the side of the vehicle.

A ladder that provides access to a rack on a vehicle having a pair of legs that form a neck that is adjustable in length is provided. A connector operatively associated with the neck for attachment to the rack is provided. A pair of stand-offs, wherein one of the pair of stand-offs is connected to one of the pair of legs and the other of the pair of stand-offs is connected to the other of the pair of legs to permit the ladder to rest against the side the vehicle is provided.

### BRIEF DESCRIPTION OF DRAWINGS

Other and further advantages, benefits and features of the present disclosure will be understood by reference to the following specification in conjunction with the accompanying drawings, in which like reference characters denote like elements.

FIG. 1 illustrates a front view of the ladder according a first embodiment of the present invention;

FIG. 2 illustrates a side view of the ladder according to the present invention;

FIG. 3 illustrates a rear perspective view of the ladder according to the present invention;

FIG. 4. Illustrates the ladder according to the present invention connected to a rack of a vehicle;

FIG. 5 illustrates a detailed view a connector configured as a hook according to a first embodiment of the present invention; and

FIG. 6 illustrates a detailed view of a connector configured as a cuff according to a second embodiment of the present invention.

### DETAILED DESCRIPTION OF THE INVENTION

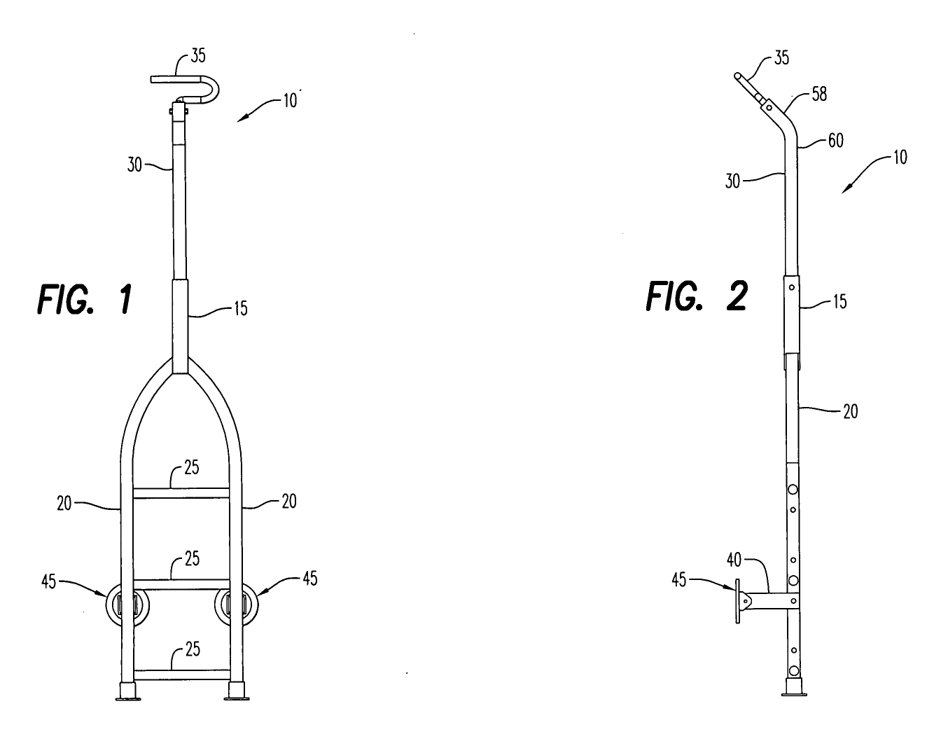

Referring to FIG. 1, a ladder is shown and generally referred to using reference numeral 10. Ladder 10 has a two legs 20 that converge to form neck 15 that extends from legs 20. Ladder 10 has multiple rungs 25 that connect legs 20 and provide support for a person using ladder 10. While ladder 10 is shown as having three rungs 25, ladder 10 could have as many as eight rungs to accommodate the needs of the user and the size of the vehicle.

Referring to FIG. 2, neck 15 has a neck extension 30 having a connector, configured as a hook 35, according to the first embodiment of the present invention. Neck extension 30 is curved and has an upper portion 58 that lies outside of the plane of neck 15 and legs 20. Neck extension 50 also has a lower portion 60. Neck extension 30 is preferably telescopically received inside of neck 15. Neck extension 30 is able to slide inside of neck 15 to increase or decrease the length of ladder 10. By being adjustable, the distance between hook 35 that connects to vehicle and rungs 25 can be increased or decreased depending upon the height of the user or the vehicle to which the ladder 10 is connected.

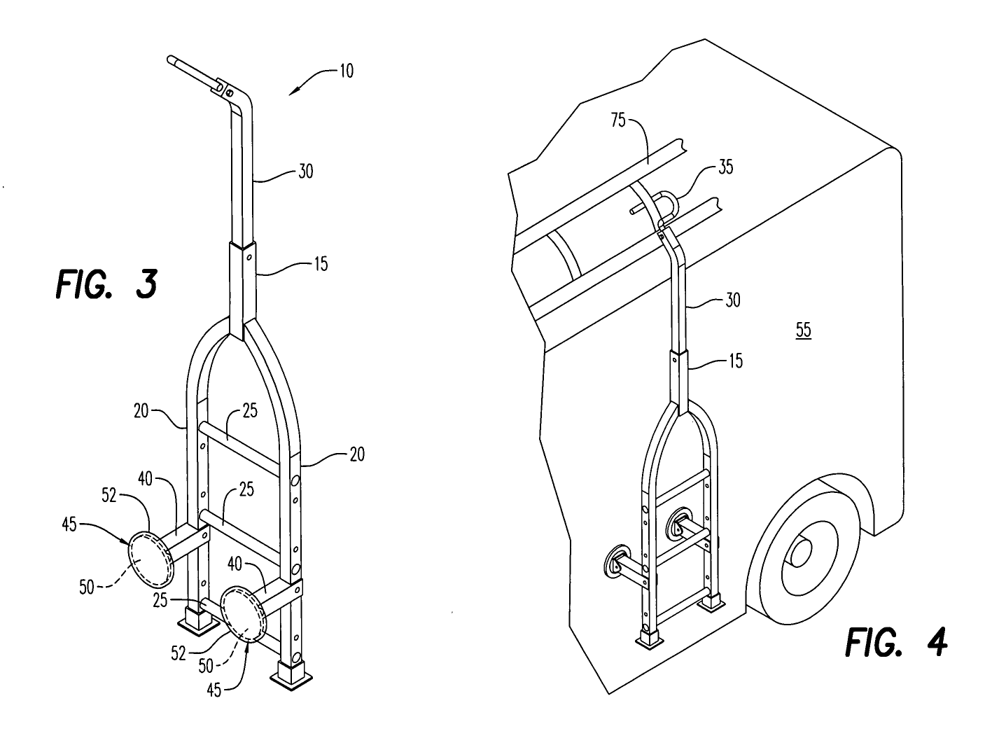

Referring to FIG. 3, legs 20 each have a stand-off support 40 to allow ladder 10 to rest against a substantially vertical surface of vehicle. Each stand-off support 40 is generally perpendicular to legs 20. Each stand-off support 40 has a circular base 45 that is sized to provide a flat surface that will be stable against side of vehicle 10. The length of each stand-off 40 is approximately five inches although any convenient length could be used that would maintain stability of ladder 10. Each circular base 45 is covered with a soft rubber material 50 to provide a soft surface against the finish of the vehicle and to provide friction between surface of vehicle and each stand-off 40 to prevent movement of ladder during use. While rubber is preferable, any such material that would prevent sliding of ladder against vehicle and protect vehicle finish could also be used. Preferably, soft rubber material 50 of each circular base 45 is covered with a bonnet 52 made from a material such as fleece or any other soft material that would protect finish of side of vehicle without compromising the friction between rubber and vehicle. Furthermore, each stand-off 40 is adjustable along the length of legs 20 to accommodate for any irregular features that may exist on the side of a vehicle that would cause instability. While the figures show two stand-offs a plurality of standoffs could also be used to provide necessary stability. Each leg could additionally have at least one stand-off removable connected thereto.

Referring to FIG. 4, stand-offs 40 permit ladder 10 to have a relatively shorter length to be supported against side of vehicle 55, as opposed to resting against ground for stability. The shorter hanging ladder of the present invention is lighter than a similar full length ladder that rests against the ground for stability.

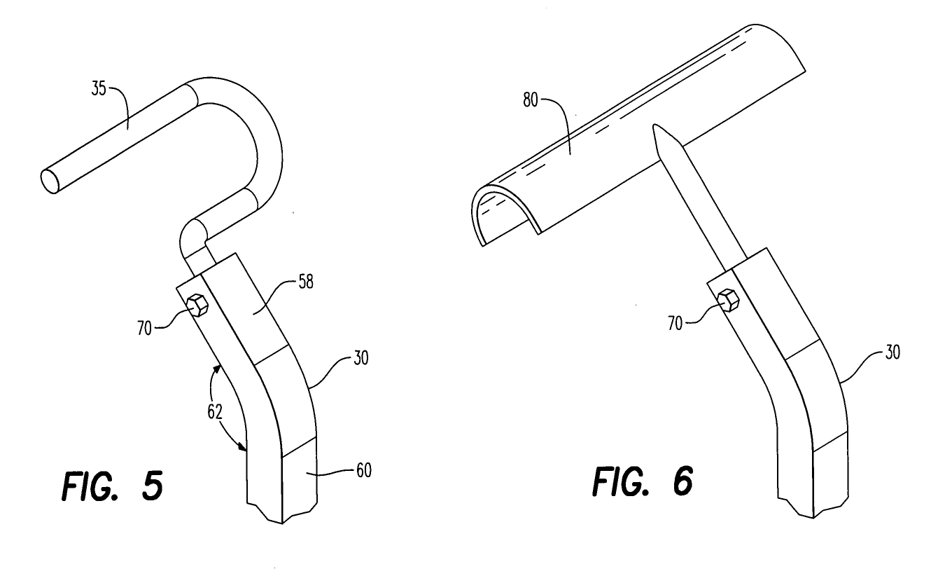

Referring to FIGS. 4 and 5, hook 35 extends from neck extension 30 to connect to a vehicle having a roof rack 75 that is affixed to the roof of a vehicle 55. An enlarged view shows at FIG. 5, hook 35 and neck extension 30 of the present invention. Neck extension 30 has an upper portion 58 and a lower portion 60 that is co-linear with neck 15. Angle 62 between upper portion 58 and lower portion 60 permits a curvature to allow ladder 10 to hang in a parallel orientation relative to a side of vehicle 55 during use. Hook 35 has a horizontal orientation during use. Hook 35 can be detached from neck extension 30 by removal of a mechanism such as a bolt 70 that would maintain position of hook 35 inside of neck extension 30. Hook 35 could be removed to insert a larger or longer hook that would accommodate racks that are positioned more to the center of the roof of a vehicle. According to a second embodiment of the present invention, hook 35 could alternatively be replaced with cuff 80 as shown in FIG. 6. Cuff 80 is structured to securedly rest on top of roof rack 75 as opposed to hook to roof rack 75. Similar to hook 35, cuff 80 is detachable from neck extension 30 for adjustment or removal.

While ladder 10 is has been described and shown attached to a roof rack of a van, ladder 10 could also connect to a rack of a truck, a recreational vehicle, luggage racks on cars or boat side rails for example. Further ladder 10 is preferably made from light weight aluminum or any other strong inexpensive material. Alternatively, ladder 10 could also be made from steel, fiberglass or injection molded plastic.

Additionally, the ladder could be used to provide access to a structure or egress from a structure. In the event of a fire or some other emergency for example, the ladder of the present invention could be used to enable entry or egress from a window for example.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

I claim:

1. A ladder that provides access to a rack on a roof and/or side of a vehicle comprising:
a neck connected to a pair of legs,
a plurality of rungs separating said pair of legs;
a pair of stand-offs, wherein one of said pair of stand-offs is connected to one of said pair of legs and the other of said pair of stand-off is connected to the other of the pair of legs; and
a neck extension connected to said neck having a connector that removably attaches to the rack to permit the ladder to hang at the side of the vehicle.

2. The ladder according to claim 1, wherein said connector is a hook that attaches to the rack.

3. The ladder according to claim 1, wherein said connector is a cuff that attaches to the rack.

4. The ladder according to claim 1, wherein said neck extension is telescopically received in said neck.

5. The ladder according to claim 1, wherein said neck extension is releasably attached to said neck to prevent relative movement therebetween during use.

6. The ladder according to claim 1, wherein said plurality of rungs number from three rungs to eight rungs.

7. The ladder according to claim 1, wherein each of said pair of stand-offs is perpendicular to one of said pair of legs.

8. The ladder according to claim 7, wherein each of said pair of stand-offs has a circular base connected thereto to rest against a side of the vehicle.

9. The ladder according to claim 8, wherein said circular base is a covered with a rubber pad.

10. The ladder according to claim 9, wherein said rubber pad is covered with a fabric bonnet.

11. The ladder according to claim 1, wherein each of said pair of stand-offs is removably connected to a respective leg for repositioning along said leg.

12. A ladder that provides access to a rack on a vehicle comprising:
a pair of legs that form a neck;
said neck being adjustable in length;
a connector operatively associated with said neck for attachment to the rack; and
a pair of stand-offs, wherein one of said stand-offs is connected to one of the pair of legs and the other of the pair of stand-offs is connected to the other of the pair of legs to permit the ladder to rest against the side the vehicle.

13. The ladder according to claim 12, wherein said connector is a hook that attaches to the rack.

14. The ladder according to claim 12, wherein said connector is a cuff that attaches to the rack.

15. The ladder according to claim 12, wherein said neck further comprises a neck extension is telescopically received in said neck.

16. The ladder according to claim 15, wherein said neck extension is releasably secured to said neck to prevent relative movement therebetween during use.

17. The ladder according to claim 12, further comprising a plurality of rungs disposed between said pair of legs.

18. The ladder according to claim 17, wherein said plurality of rungs number from three rungs to eight rungs.

19. The ladder according to claim 12, wherein each of said pair of stand-offs is perpendicular to one of said pair of legs to which it is connected.

20. The ladder according to claim 19, wherein each of said pair of stand-offs is removably connected to said leg to which it is connected.

21. The ladder according to claim 12, wherein each of said pair of stand-offs has a circular base connected thereto to rest against a side of the vehicle.

22. The ladder according to claim 21, wherein said circular base is a covered with a rubber pad.

23. The ladder according to claim 22, wherein said rubber pad is covered with a fabric bonnet.

24. The ladder according to claim 12, wherein the vehicle is one of a van, a truck, a boat or a recreational vehicle.

25. An assembly that provides access to a rack disposed on either a roof or a side of a vehicle or structure, said assembly comprising:
a ladder comprising a first leg and a second leg, and a plurality of rungs disposed between said legs;
a plurality of stand-offs, wherein at least one stand-off is connected to said first leg and at least one other stand-off is connected to said second leg; and
a fastener that is connected to said ladder and said rack.

26. The assembly of claim 26, wherein said fastener is a removable fastener.

27. The assembly of claim 26, wherein said ladders ands on a side of the vehicle or structure.
